(19) United States
(12) Patent Application Publication
(10) Pub. No.: US 2022/0254200 A1
(43) Pub. Date: Aug. 11, 2022

(54) ADAS MONITORING EVENT SYSTEM

(71) Applicant: NEXTBOX CO., LTD., Goyang-si (KR)

(72) Inventor: Yeong Hun KIM, Goyang-si (KR)

(21) Appl. No.: 17/367,676

(22) Filed: Jul. 6, 2021

(30) Foreign Application Priority Data
Feb. 9, 2021 (KR) 10-2021-0018031

(51) Int. Cl. G07C 5/08; B60Q 9/00; B60W 30/09; B60W 30/14; B60W 30/12

(52) U.S. Cl. CPC G07C 5/085; B60Q 9/008; B60W 30/09; B60W 30/143; B60W 30/12; B60W 2556/60; B60W 2510/10; B60W 2420/54; B60W 2420/42; B60W 2510/06; B60W 2510/18; B60W 2510/20; B60W 2420/52

(57) ABSTRACT

The ADAS monitoring event system of the present invention has the advantages of checking whether an advanced driver assistance system (ADAS) is operating appropriately and a state during driving based on vehicle-related data, increasing the safety of autonomous driving, and resolving disputes in the event of a traffic accident.

### CROSS-REFERENCE TO RELATED APPLICATION

This application claims the benefit of Korean Patent Application No. 10-2021-0018031 filed on Feb. 9, 2021, which is hereby incorporated by reference herein in its entirety.

### BACKGROUND

### 1. Technical Field

The present invention relates to an Advanced Driver Assistance System (ADAS) monitoring event system.

### 2. Description of the Related Art

Many Advanced Driver Assistance Systems (ADASs) have been developed for autonomous driving. Although many automobile companies have developed ADASs and introduced them into vehicles through many tests and verifications, it is true that they are being developed through the application of them to limited environments and drivers. It is true that it is almost impossible to verify ADASs in all driving environments in which users who actually purchase and ride vehicles travel.

Therefore, the verification of users' actual driving information regarding how often such an ADAS is activated, how much it lowers the accident rate when activated, and how many accidents occur even when the ADAS system is activated in all road environments in which the users drive is insufficient.

Recently, autonomous driving recorders are being developed in preparation for vehicles having an autonomous driving level 3 or 4. The first purpose of such autonomous driving recorders is to determine whether a driver or the manufacturer of an autonomous vehicle is responsible for the driving of the autonomous vehicle. Current autonomous driving recorders store and manage all data about driving. However, since autonomous vehicles generate TB or more of data per day, it is almost impossible to manage such big data when considering the cost of managing all autonomous vehicles around the world and managing them in the cloud.

In addition, these pieces of vehicle data are stored countless times in raw data format that is hard to distinguish although individual IDs are assigned. It is very difficult to find and analyze these pieces of data one by one. In the case of Allianz insurance company, the company mentions that there is no problem in data extraction but there are limitations to accident analysis while specifying data access conditions to policyholders for autonomous driving level 3 and 4 vehicles. This is also disproof for the fact that it is difficult to classify and analyze a lot of raw data.

In Korean Patent No. 10-2111596, the present applicant discloses a method and apparatus for analyzing an accident using a vehicle sensor and vehicle information via big data, the apparatus including an event occurrence determination unit connected to a sensor or an imaging device mounted on a vehicle, a display control unit connected to the image display device of the vehicle, and a vehicle control unit configured to include a storage unit. The event occurrence determination unit measures the speed and distance of objects around a vehicle, determines, when the relative speed calculated based on the speed is equal to or higher than a predetermined value and the distance is equal to or shorter than a predetermined value, the closest forward object to be a first monitoring target object and the closest rearward object to be a second monitoring target object, and then generates an event. In addition, the storage unit stores the speed and distance information of the first and second monitoring target objects in the form of text and image data, and the display control unit transmits the text and image data to the image display device so that the information about the first or second monitoring target object is displayed thereon.

However, the data classification for the verification and analysis of the effectiveness of ADASs, which are the core of autonomous vehicles, is not sufficiently supported by the above-described technology, so that an ADAS monitoring event system according to the present invention has been contrived.

### SUMMARY

The present invention has been conceived to overcome the above-described problems, and an object of the present invention is to provide an ADAS monitoring event system that improves safety and reliability by monitoring the functions and statuses of ADASs and analyzing data.

According to an aspect of the present invention, there is provided an advanced driver assistance system (ADAS) monitoring event system, the ADAS monitoring event system being connected to at least one ADAS and vehicle-mounted devices, the ADAS monitoring event system including a central computation control unit, an ADAS signal reception unit, a vehicle data reception unit, and an ADAS data storage unit; wherein the vehicle-mounted devices include a sensor, an in-vehicle module, and a GPS module; wherein the ADAS signal reception unit receives a signal when an ADAS is driven, and the central computation control unit determines that an event occurs when receiving an ADAS driving signal, receives vehicle-related data from the sensor, the in-vehicle module, and the GPS module via the vehicle data reception unit, associates them based on the received vehicle-related data and ADAS information, and stores sorted first data in the ADAS data storage unit; and wherein the central computation control unit analyze a correlation between the ADAS and the vehicle-related data based on the first data and stores results of the analysis as second data, and the second data includes an ADAS field and a vehicle data field.

The ADAS monitoring event system may further include an ADAS analysis data storage unit, and the second data may be stored in the ADAS analysis data storage unit and further include a period field.

The ADAS monitoring event system may further include an accident occurrence data storage unit; and, when a vehicle accident occurs, the data of the ADAS data storage unit may be separately stored in the accident occurrence data storage unit before and after the occurrence of the accident, so that ADAS operation status and vehicle-related data at the moment the vehicle accident occurs can be secured.

The ADAS monitoring event system may further include a dangerous area event storage unit, and, when a vehicle enters a protected area or a dangerous area, an event may be generated and thus the vehicle-related data received from the sensor, the in-vehicle module, and the GPS module is stored in the dangerous area event storage unit.

The ADAS may be at least one of a Forward Collision Warning (FCW) system, a Forward Collision-Avoidance Assistance (FCA) system, an Autonomous Emergency Braking (AEB) system, an Adaptive Cruise Control (ACC) system, a Blind-spot Collision Warning (BCW) system, a Lane Departure Warning (LDW) system, a Lane Keeping System (LKS), a Lane Keeping Assistance System (LKAS), and a Rear Collision Warning (RCW) system.

The vehicle-related data may include, among first information regarding radar, LiDAR, ultrasonic, and vision sensors, second information regarding an engine, brake, gear, and steering wheel of the vehicle, and third information regarding location data of the GPS module, at least one piece of data pertaining to the first information, at least one piece of data pertaining to the second information, and at least one piece of data pertaining to the third information.

The protected area or the dangerous area may be one of a “child protection area,” a “senior protection area,” and an “accident-prone area.”

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing an overview of the monitoring event system of the present invention;

FIG. 2 is a diagram showing the structure of the ADAS monitoring event system and the connections between ADASs and vehicle-mounted devices;

FIG. 3 is a flowchart showing the operational flow of the ADAS monitoring event system of the present invention;

FIG. 4 is a diagram showing an example of the structure of first data stored in an ADAS data storage unit;

FIG. 5 is a diagram showing an example of the structure of second data stored in an ADAS analysis data storage unit; and

FIG. 6 is a view showing an example of a sign indicative of a protected area.

### DETAILED DESCRIPTION

Embodiments according to the present invention are merely examples intended to help the understanding of the present invention, and the present invention is not limited to these embodiments. The present invention may be composed of a combination of at least any one of the individual components and functions included in the individual embodiments.

The Advanced Driver Assistance System (ADAS) monitoring event system 1 of the present invention may be mounted in a vehicle or present in a server outside the vehicle, and may communicate with the corresponding vehicle via a wireless connection.

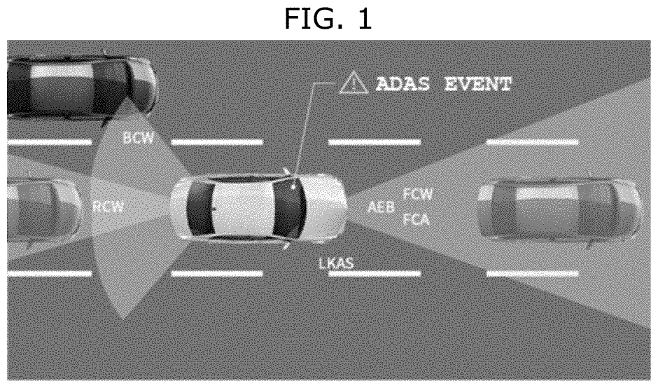

The vehicle should be interpreted in the maximally broadest sense including commercial vehicles as well as passenger cars. As shown in FIG. 1, the monitoring event system 1 is connected to various ADASs 2, and it is determined that an event occurs when the ADASs 2 start driving.

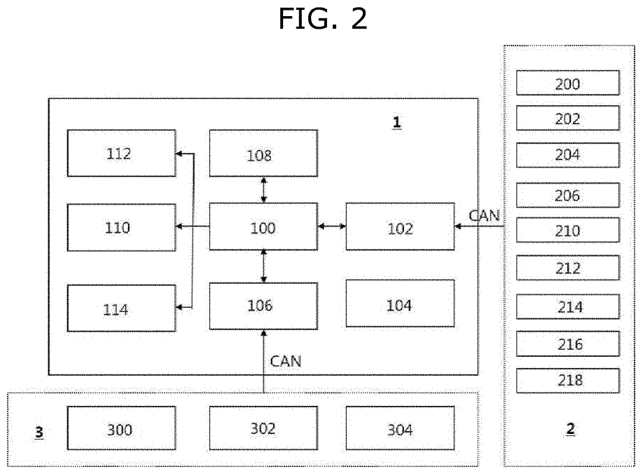

FIG. 2 is a specific embodiment of FIG. 1. When the ADAS monitoring event system 1 is mounted in a vehicle, it may be connected to the ADASs 2 and vehicle-mounted devices 3.

First, the ADAS monitoring event system 1 includes a central computation control unit 100, an ADAS signal reception unit 102, a power supply unit 104, a vehicle data reception unit 106, an ADAS data storage unit 108, an ADAS analysis data storage unit 110, an accident occurrence data storage unit 112, and a dangerous area event storage unit 114.

The ADASs 2 include a Forward Collision Warning (FCW) system 200, a Forward Collision-Avoidance Assistance (FCA) system 202, an Autonomous Emergency Braking (AEB) system (204), an Adaptive Cruise Control (ACC) system 206, a Blind-spot Collision Warning (BCW) system 208, a Lane Departure Warning (LDW) system 212, a Lane Keeping System (LKS) 214, a Lane Keeping Assistance System (LKAS) 216, and a Rear Collision Warning (RCW) system 218. However, depending on the vehicle, only some of the ADASs may be installed. The ADASs 2 should be interpreted in the broadest sense including all systems currently under development or to be developed in the future, such as a system configured to warn a driver by flashing a turn signal light rapidly when a collision with a vehicle approaching from behind is imminent, a system configured to allow seat belt tensioners to tighten front seat belts when the vehicle speed is less than km/h and it detects a risk of collision with a vehicle approaching from behind, or a system configured to reduce forward acceleration by applying braking in the event of a collision while the vehicle is stationary.

The ADAS data storage unit 108, the ADAS analysis data storage unit 110, the accident occurrence data storage unit 112, and the danger area event storage unit 114 are spaces where data is stored after the computation and analysis of the central computation control unit 100, as will be described later. These units may be collectively referred to as “memory” or a “storage unit” in that they are not physically distinguished from each other. However, since they have different characteristics and functions in the present invention, they will be separately described for the sake of convenience.

The vehicle-mounted devices 3 include a sensor 300, an in-vehicle part/module 302, and a GPS module 304. The sensor 300 is a component configured to be mounted on a vehicle and collect data from an external object or an environment, such as a radar, LiDAR, ultrasonic wave, or vision sensor. The in-vehicle part or module 30 refers to one having a function of qualitatively displaying performance during operation (e.g., vehicle speed) or detecting whether the part or module is being driven (whether a brake pedal is depressed) among the driving-related parts or modules installed inside and outside the vehicle, such as the engine, brake, gear, steering wheel, and tire of the vehicle. Although these modules also usually have a built-in sensor, they are not separate sensors configured to detect an external object or environment, and thus are distinguished from the sensor 300 for the sake of convenience. As is well known, the GPS module 304 is a device configured to track the location of the vehicle in real time while communicating with satellites.

The power supply unit 104 is intended to supply power to the ADAS monitoring event system 1, and may be connected to the vehicle's battery or provided with an independent power source.

The ADAS monitoring event system 1 of the present invention is connected to the ADASs 2 and the vehicle-mounted devices 3 over a car area network (CAN) or Ethernet. The following description will be given on the assumption that the data of the ADASs 2 and the vehicle-mounted devices 3 are received over such a network.

The ADAS signal reception unit 102 of the ADAS monitoring event system 1 of the present invention receives a signal when at least one of the listed ADASs 2 is driven. The ADASs 2 do not drive when the vehicle is turned off, the BCW system 208, the RCW system 218 or a parking assistance system is driven when the vehicle is parked, and more ADASs are driven when the vehicle is driving. When an ADAS driving signal is received, the central computation control unit 100 determines that it is an event, and issues a command to receive vehicle-related data from the sensor 300, the in-vehicle module 302, and the GPS module 304.

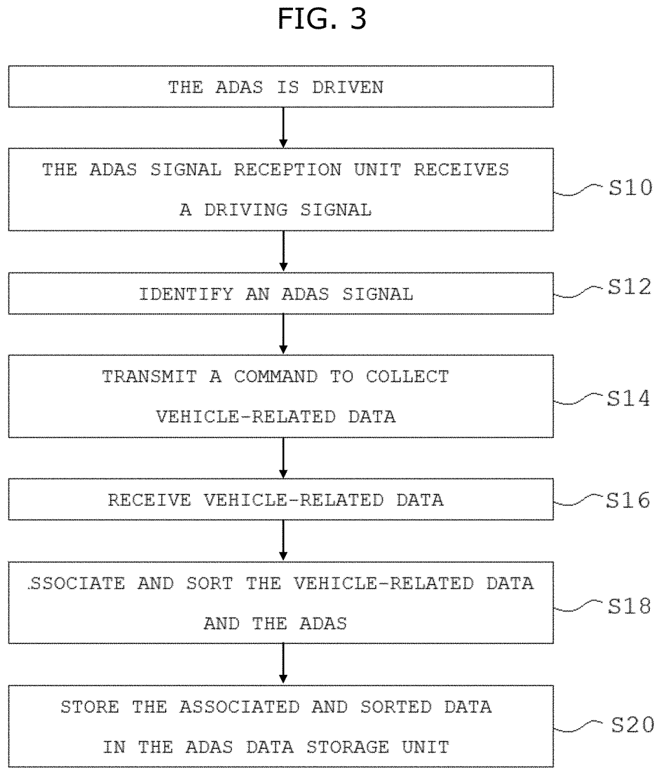

FIG. 3 is a flowchart showing the operation flow of the ADAS monitoring event system 1 of the present invention.

When the ADASs 2 are driven, the ADAS signal reception unit 102 receives a driving signal at step S10, as described above. The central computation control unit 100 identifies the ADAS signal at step S12, and transmits a data collection command to the vehicle data reception unit 106 at step S14. Then, the vehicle data reception unit 106 collects all data 310 on the vehicle from the sensor 300, the in-vehicle module 302, and the GPS module 304 at step S16. The data 310 includes whether the various sensors 300 mounted on the vehicle operate and related information data—the distances between the vehicle and surrounding objects, pedestrian identification, the image data of a black box, whether the part or module 302 operates, and related information data—RPM, acceleration, steering angle, whether the brake is depressed, and information about the location of the GPS module 304, but is not limited thereto.

The central computation control unit 100 associates them based on the received vehicle data 300 and ADAS information, sorts them at step S18, and stores them in the ADAS data storage unit 108 at step S20.

The above process is an event that always occurs when the ADASs 2 of the vehicle are being driven. When the ADASs 2 are terminated, the ADAS monitoring event system 1 does not work.

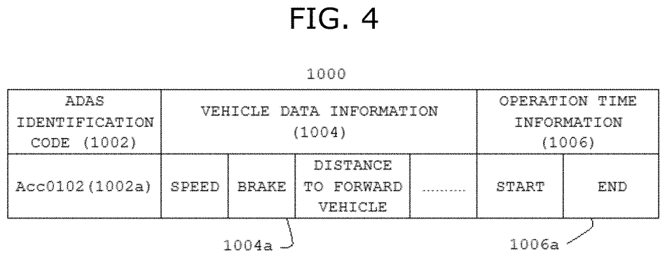

FIG. 4 shows an example of the structure of the first data 1000 stored in the ADAS data storage unit 108. The first data 1000 is a higher item, and includes an ADAS identification code 1002, vehicle data information 1004, and time information 1006. The ADAS identification code 1002 is driven, and stores the type of ADAS from which the signal has been received as a unique code. For example, the code “acc0102” representative of the ACC system 206 is stored in a sub-item 1002a. In the sub-item 1004a of the vehicle data information 1004, information such as vehicle speed, whether the brake pedal is depressed, a distance to a front vehicle, a distance to a rear vehicle, a gear state, etc. are stored. In the sub-item 1006a of the time information 1006, the drive start time and drive end time of a specific ADAS are recorded.

The highest priority among the items of the structure of the first data 1000 stored in the ADAS data storage unit 108 is assigned to the ADAS identification code 1002, and the remaining data is associated and sorted to be subordinated thereto. Except for this point, it may be considered the first data structure 1000 has the characteristic of being relatively close to raw data.

The first data 1000 is an example. For example, various changes are possible, such as grouping vehicle data information by placing several intermediate classes instead of directly placing the sub-items 1004a directly under the vehicle data information 1004.

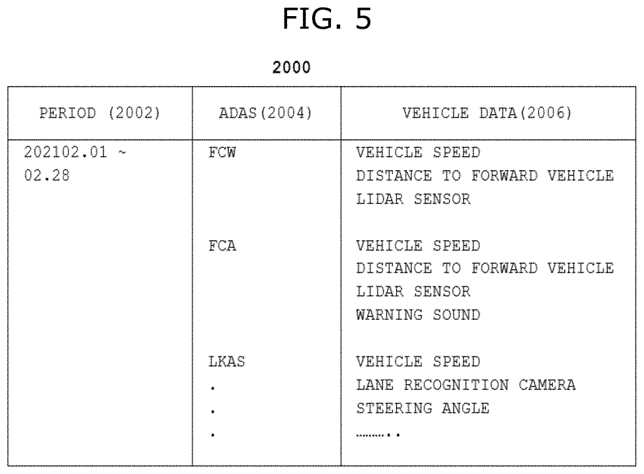

FIG. 5 shows an example of the structure of the second data 2000 stored in the ADAS analysis data storage unit 110. The central computation control unit 100 analyzes and stores the correlation between the ADAS 2 and the vehicle data 300 based on the first data 1000. This process is not performed only when the ADASs 2 are in operation as shown in FIG. 3, and thus is described separately.

The structure of the second data 2000 includes, for example, a period field 2002, an ADAS field 2004, and a vehicle data field 2006. In the period field 2002, for example, a specific period (e.g., Feb. 1, 2021 to Feb. 28, 2021) is input. In the ADAS field 2004, ADASs used during the period are sorted in order of frequency of use. In the vehicle data field 2006, data having high technical relevance for each of the corresponding ADAS 2 are extracted and stored. Vehicle speed information is information related to almost all the ADASs. Data related to a preceding vehicle is important for the FCW system and the FCA system, and information about whether the brake pedal is depressed is also important for the AEB system. From the structure of the second data 2000, the types of one or more ADASs frequently used in the vehicle and vehicle data information related thereto may be sequentially checked and analyzed.

The second data 2000 shows an example. For example, by placing the vehicle data field 2006 after the period field 2002 and arranging the ADAS field 2004 subordinate to the vehicle data field 2006, whether which ADAS 2 is frequently used for specific vehicle data (e.g., vehicle speed) may be analyzed.

Based on the second data 2000, for example, data information on how much the LKAS 216 was operated, what kind of driving the driver or the autonomous driving SW performed during operation (in case of autonomous driving level 3 or 4 or later), how much the accident rate was lowered after operation, and what points need to be improved for further advancement in case of an accident after operation, among the numerous types of information of the vehicle, may be classified and ensured.

Furthermore, the ADAS monitoring event system 1 of the present invention separately stores the data of the ADAS data storage unit 108 in the accident occurrence data storage unit 112 before and after the occurrence of a vehicle accident when the vehicle accident occurs. Then, the ADAS operation state at the moment the vehicle accident occurs and specific vehicle information data at the moment may be obtained, so that it may be possible to determine the ADAS 2 whose operation has failed or which does not meet operation requirements as well as whether there is a driver's fault. Such information accumulated based on multiple vehicles should be fed back to companies that manufacture or assemble ADASs, and it will help to enhance consumer confidence and safety, as information about whether an appropriate price corresponding to each ADAS is reflected in a car purchase price

Furthermore, the ADAS monitoring event system 1 of the present invention determines that a separate event occurs when the vehicle drives in a dangerous area, and stores an overall driving record in the dangerous area event storage unit 114.

In the traffic safety comprehensive measures, the analysis of pedestrian fatalities shows that 52% (898 people) of accidents occur on backside roads having high pedestrian traffic around residential and commercial areas. The reason for this is that it is difficult to distinguish a sidewalk from a roadway on the backside roads, and drivers tend to speed because they are not aware of the speed limit zone.

The government also announced the ‘improvement and management of areas vulnerable to pedestrian accidents,’ the ‘improvement of a safe environment for the protection of children while creating a customized safe environment for the transportation vulnerable,’ and the ‘strengthening the responsibility of drivers for traffic safety’ as key areas with the aim of establishing a preventive and scientific safety management system as ‘transport safety system innovation’ among future policy goals and strategies.

Speeding accidents have a mortality rate more than 10 times higher than that of general traffic accidents. When the effect of decelerating traffic accidents in places where unmanned enforcement equipment was newly installed over the past five years is analyzed, traffic accidents decreased by 22% and the number of deaths decreased by about 69%.

When this situation is taken into consideration, the ADAS monitoring event system 1 of the present invention determines a location based on the GPS module when a vehicle enters a protected area defined on a road, such as a protected area, and stores information from the sensor 300, the in-vehicle part or module 302, and the GPS module 304 over an overall area is stored in the dangerous area event storage unit 114.

Then, it may be possible to strengthen a driver's responsibility and secure evidence data due to the continuous event operation inside the protected area. In addition, since key information such as vehicle location, speed, RPM, steering and brake information is stored by checking the event data of the protected area, the effect of reducing disputes may be achieved.

Data starts to be recorded in the hazardous area event storage unit 114 from the moment the GPS module 304 recognizes a “child protection area,” a “senior protection area,” or an “accident frequency section,” and ends after a predetermined time (e.g., 3 minutes) or at the moment when an overall area or section has been passed.

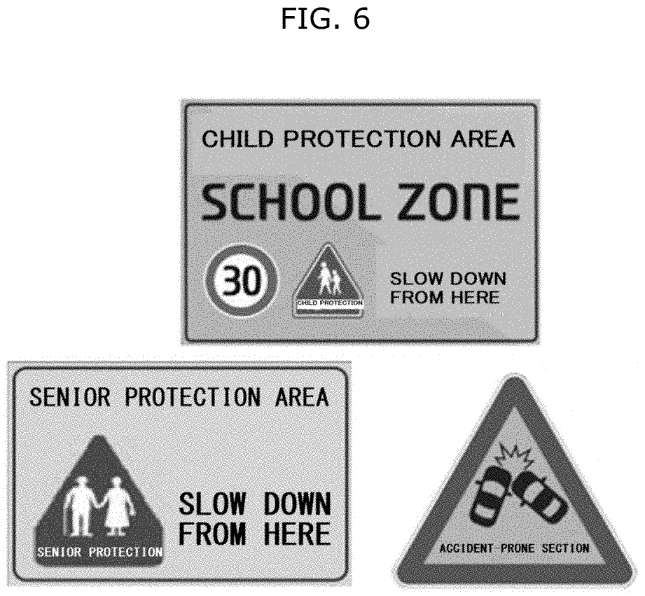

When the GPS module 304 is not present or has a malfunction, the event may be started from the moment the front camera recognizes the sign shown in FIG. 6, and the event may be ended after a predetermined time has elapsed.

The ADAS monitoring event system 1 of the present invention may be mounted in or separated from a vehicle. When separated, it may be connected to a computer or (cloud) server to check various data and analyze it in various ways. The management of data as well as statistics about ADAS accident rate reduction effects is facilitated because not all driving data, but data that is classified when the ADASs 2 are activated and events are activated is used.

In addition, a statistical report may be provided by classifying data, grouped as soon as the ADASs 2 are monitored and data is stored, and transmitting the data to the server. When data is acquired over a long period of time, statistics regarding what extent an accident is prevented when the ADAS 2 is activated, to what extent an accident occurs, how much accident damage has been reduced, and which evasion route is the safest when the vehicle performs evasion may be determined through data. In addition, it may be possible to check the data of which company's ADAS is safer and more efficient, and the problems of the existing ADASs may be discovered, which may help to improve the next-generation ADAS and contribute to safer autonomous driving.

According to the present invention, the management of data as well as statistics about ADAS accident rate reduction effects is facilitated because not all the driving data of a vehicle, but data that is classified when the ADASs are activated and events are activated is used.

According to the present invention, ADAS-related data is acquired over a long period of time, and the degree of accident prevention, a reduction in accident damage, and safe avoidance routes for a vehicle are determined, thereby providing the effect of improving the safety and efficiency of ADASs and contributing to safe autonomous driving.

The present invention may provide the effects of strengthening a driver's responsibility, securing evidence data, and reducing disputes due to the continuous activation of events inside a protected area.

Although the embodiments of the present invention have been described above, they do not limit the present invention, and various modifications and variations may be made to the present invention.

What is claimed is:

1. An Advanced Driver Assistance System (ADAS) monitoring event system, the ADAS monitoring event system being connected to at least one ADAS and vehicle-mounted devices, the ADAS monitoring event system comprising a central computation control unit, an ADAS signal reception unit, a vehicle data reception unit, and an ADAS data storage unit;
wherein the vehicle-mounted devices comprise a sensor, an in-vehicle module, and a GPS module;
wherein the ADAS signal reception unit receives a signal when an ADAS is driven, and the central computation control unit determines that an event occurs when receiving an ADAS driving signal, receives vehicle-related data from the sensor, the in-vehicle module, and the GPS module via the vehicle data reception unit, associates them based on the received vehicle-related data and ADAS information, and stores sorted first data in the ADAS data storage unit; and
wherein the central computation control unit analyze a correlation between the ADAS and the vehicle-related data based on the first data and stores results of the analysis as second data, and the second data includes an ADAS field and a vehicle data field.

2. The ADAS monitoring event system of claim 1, further comprising an ADAS analysis data storage unit, wherein the second data is stored in the ADAS analysis data storage unit and further includes a period field.

3. An Advanced Driver Assistance System (ADAS) monitoring event system, the ADAS monitoring event system being connected to at least one ADAS and vehicle-mounted devices, the ADAS monitoring event system comprising a central computation control unit, an ADAS signal reception unit, a vehicle data reception unit, and an ADAS data storage unit;
wherein the vehicle-mounted devices comprise a sensor, an in-vehicle module, and a GPS module;
wherein the ADAS signal reception unit receives a signal when an ADAS is driven, and the central computation control unit determines that an event occurs when receiving an ADAS driving signal, receives vehicle-related data from the sensor, the in-vehicle module, and the GPS module via the vehicle data reception unit, associates them based on the received vehicle-related data and ADAS information, and stores sorted first data in the ADAS data storage unit;
wherein the ADAS monitoring event system further comprises an accident occurrence data storage unit; and
wherein when a vehicle accident occurs, data of the ADAS data storage unit is separately stored in the accident occurrence data storage unit before and after the occurrence of the accident, so that ADAS operation status and vehicle-related data at a moment the vehicle accident occurs can be secured.

4. An Advanced Driver Assistance System (ADAS) monitoring event system, the ADAS monitoring event system being connected to at least one ADAS and vehicle-mounted devices, the ADAS monitoring event system comprising a central computation control unit, an ADAS signal reception unit, a vehicle data reception unit, and an ADAS data storage unit;
wherein the vehicle-mounted devices comprise a sensor, an in-vehicle module, and a GPS module;
wherein the ADAS signal reception unit receives a signal when an ADAS is driven, and the central computation control unit determines that an event occurs when receiving an ADAS driving signal, receives vehicle-related data from the sensor, the in-vehicle module, and the GPS module via the vehicle data reception unit, associates them based on the received vehicle-related data and ADAS information, and stores sorted first data in the ADAS data storage unit;
wherein the ADAS monitoring event system further comprises an dangerous area event storage unit; and
wherein when a vehicle enters a protected area or a dangerous area, an event is generated and thus the vehicle-related data received from the sensor, the in-vehicle module, and the GPS module is stored in the dangerous area event storage unit.

5. The ADAS monitoring event system of claim 1, wherein the ADAS is at least one of a Forward Collision Warning (FCW) system, a Forward Collision-Avoidance Assistance (FCA) system, an Autonomous Emergency Braking (AEB) system, an Adaptive Cruise Control (ACC) system, a Blind-spot Collision Warning (BCW) system, a Lane Departure Warning (LDW) system, a Lane Keeping System (LKS), a Lane Keeping Assistance System (LKAS), and a Rear Collision Warning (RCW) system.

6. The ADAS monitoring event system of claim 3, wherein the ADAS is at least one of a Forward Collision Warning (FCW) system, a Forward Collision-Avoidance Assistance (FCA) system, an Autonomous Emergency Braking (AEB) system, an Adaptive Cruise Control (ACC) system, a Blind-spot Collision Warning (BCW) system, a Lane Departure Warning (LDW) system, a Lane Keeping System (LKS), a Lane Keeping Assistance System (LKAS), and a Rear Collision Warning (RCW) system.

7. The ADAS monitoring event system of claim 4, wherein the ADAS is at least one of a Forward Collision Warning (FCW) system, a Forward Collision-Avoidance Assistance (FCA) system, an Autonomous Emergency Braking (AEB) system, an Adaptive Cruise Control (ACC) system, a Blind-spot Collision Warning (BCW) system, a Lane Departure Warning (LDW) system, a Lane Keeping System (LKS), a Lane Keeping Assistance System (LKAS), and a Rear Collision Warning (RCW) system.

8. The ADAS monitoring event system of claim 1, wherein the vehicle-related data includes, among first information regarding radar, LiDAR, ultrasonic, and vision sensors, second information regarding an engine, brake, gear, and steering wheel of the vehicle, and third information regarding location data of the GPS module, at least one piece of data pertaining to the first information, at least one piece of data pertaining to the second information, and at least one piece of data pertaining to the third information.

9. The ADAS monitoring event system of claim 3, wherein the vehicle-related data includes, among first information regarding radar, LiDAR, ultrasonic, and vision sensors, second information regarding an engine, brake, gear, and steering wheel of the vehicle, and third information regarding location data of the GPS module, at least one piece of data pertaining to the first information, at least one piece of data pertaining to the second information, and at least one piece of data pertaining to the third information.

10. The ADAS monitoring event system of claim 4, wherein the vehicle-related data includes, among first information regarding radar, LiDAR, ultrasonic, and vision sensors, second information regarding an engine, brake, gear, and steering wheel of the vehicle, and third information regarding location data of the GPS module, at least one piece of data pertaining to the first information, at least one piece of data pertaining to the second information, and at least one piece of data pertaining to the third information.

11. The ADAS monitoring event system of claim 4, wherein the protected area or the dangerous area is one of a “child protection area,” a “senior protection area,” and an “accident-prone area.”
